(19) United States
(12) Patent Application Publication
(10) Pub. No.: US 2009/0139819 A1
(43) Pub. Date: Jun. 4, 2009

(54) Torque converter with connector plate for a clutch plate and arc spring

(75) Inventors: Jonathan Jameson, Dalton, OH (US); Craig Kneidel, Massillon, OH (US)

Correspondence Address: Davidson, Davidson & Kappel, LLC, 485 7th Avenue, 14th Floor, New York, NY, 10018, US

(73) Assignee: LuK Lamellen und Kupplungsbau Beteiligungs KG, Buehl (DE)

(21) Appl. No.: 12/313,233

(22) Filed: Nov. 18, 2008

Related U.S. Application Data
(60) Provisional application No. 61/004,641, filed on Nov. 29, 2007.

(51) Int. Cl. F16H 45/02

(52) U.S. Cl. 192/3.29

(57) ABSTRACT

A torque converter including a lock up clutch, the lock up clutch including a piston and a clutch plate, a spring, and a connector plate, the connector plate connecting to the clutch plate at a connection and drivingly engaged with the spring at a spring engagement, the connection to the clutch plate being radially outside of the spring engagement.

Priority to U.S. Provisional Patent Application Ser. No. 61/004,641, filed Nov. 29, 2007, is claimed, the entire disclosure of which is hereby incorporated by reference herein.

The present invention relates generally to a torque converter with a twin plate clutch.

### BACKGROUND

U.S. Pat. No. 6,736,247, hereby incorporated by reference herein, describes a coupling apparatus with friction zones that radially offset one another. One clutch plate is allowed to be at the same radial distance from the center as the arc spring. However, this patent does not allow both friction material surfaces to be at the same radial location as the arc spring.

Currently when a twin clutch plate is used with an arc spring damper, one or both of the clutch facings are radially lower than the arc spring so the clutch plate can bend around the outer diameter of the piston and engage the arc spring. This forces one or both of the clutch plates inward and causes a lower or limited clutch capacity.

FIG. 1 shows a cross section of a prior art torque converter 10. Torque converter 10 includes a turbine wheel 2 and a housing 4. Housing 4 encloses a piston 6, a spring 8 and a friction disk 12 of a lock-up clutch. Piston 6 has a nose 30. Friction disk 12 is attached to friction liners 14 and 16. Each friction liner having a first face 18, 22 and a second face 20, 24. First friction face 18 of friction liner 14 is attached to housing 4, while first friction face of liner 16 is attached to friction disk 12. Second friction face 20 of friction liner 14 is attached to friction disk 12 and second friction face of friction liner 16 is attached to piston 6. The friction liners 14, 16, are radially offset with respect to each other. Friction disk 12 is attached to driving lugs 28.

### SUMMARY OF THE INVENTION

The present invention provides a torque converter including a lock up clutch, the lock-up clutch including a piston and a clutch plate, a spring, and a connector plate, the connector plate connecting to the clutch plate at a connection and drivingly engaged with the spring at a spring engagement, the connection to the clutch plate being radially outside of the spring engagement.

### BRIEF DESCRIPTION OF THE DRAWINGS

FIG. 1 illustrates a cross sectional view of a fluid coupling apparatus in the current state of the art.

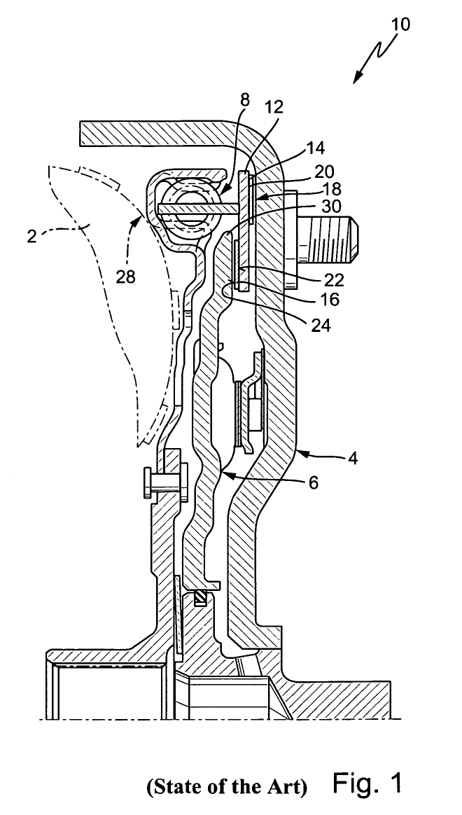

Further features and advantages of the invention will become apparent from the following detailed description taken in conjunction with the accompanying drawing in which:

FIG. 2 illustrates a sectional view of a torque converter in the present invention.

### DETAILED DESCRIPTION

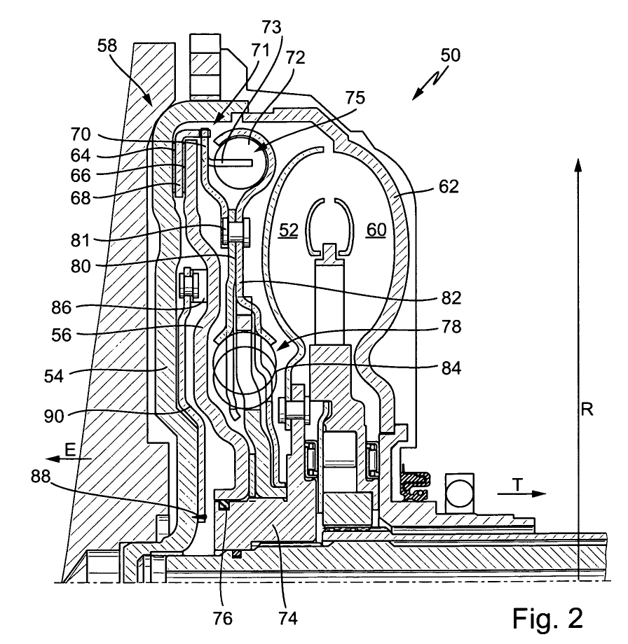

FIG. 2 shows a section of a torque converter 50. Torque converter 50 includes a housing 54, a turbine wheel 52, an impeller 60, an impeller shell 62, a lock-up clutch 58 and a damper 78. Lock-up clutch 58 includes a piston 56 and a clutch plate 68. Piston 56 contacts a turbine hub 74, attached via seal 76. Piston 56 contacts housing 54 via a drive plate 90. Piston 56 is connected to drive plate 90 using leaf springs 86 which are riveted to drive plate 90. Drive plate 90 is welded to housing 54 at a location 88. Damper 78 includes cover plates 80, 82 and springs 84.

Clutch plate 68 is between a first friction material surface 64 and a second friction material surface 66. First friction surface 64 is between piston 56 and clutch plate 68. Second friction surface 66 contacts clutch plate 68 and housing 54. As shown preferably both the friction plates 64, 66 have sections equal to or radially outward of a radius R from rotational axis to the center of a spring 72. This position can allow for greater clutch capacity.

Clutch plate 68 is attached to a connector plate 70 with spline or tabs 71, for example, at a first connection. This connection does not need to be a sliding connection. Connector plate 70 also contacts spring 72 using an extension 73 at a spring engagement 75. Springs 72 may be arc or straight springs. Connector plate 70 is centered either by springs 72 or cover plate 80. Connector plate 70 is kept from sliding towards the engine, direction E, by contacting clutch plate 68. The movement of connector plate 70 is restricted towards the transmission, direction T, by contacting cover plate 80 at a location 81, for example at a connection.

In order to damp engine vibrations with springs 72, connector plate 70 can move circumferentially relative to cover plates 80, 82. Connection at location 81 has lash to allow circumferential windup of damper 78. The connection at location 81 thus may be a non-standard spline connection with lash. Alternatively, location 81 may instead serve only to center connector plate 70, or if connector plate 70 is centered on springs 72, location 81 may axially position plate 70 in the assembly. In this case connector plate 70 only connects with cover plates 80, 82 when required for centering and/or axially positioning. By adding connector plate 70, both friction material surfaces 64, 66 may have an equal or greater radial distance from the center than spring 72.

Connector plate 70 advantageously allows the first connection at splines 71, for example, to be radially outside of spring engagement 75.

The present invention may also be used with a straight spring or other multi plate designs.

What is claimed is:

1. A torque converter comprising:
a lock-up clutch, the lock-up clutch including a piston and a clutch plate;
a spring; and
a connector plate, the connector plate connecting to the clutch plate at a connection and drivingly engaged with the spring at a spring engagement, the connection to the clutch plate being radially outside of the spring engagement.

2. The torque converter as recited in claim 1 further comprising a first friction material surface and a second friction material surface.

3. The torque converter as recited in claim 2 wherein the first and second friction material surfaces have an equal or greater radial distance from a torque converter axis than the spring.

4. The torque converter as recited in claim 2 wherein the first friction material surface is between the clutch plate and the piston and the second friction material surface is between the clutch plate and the housing.

5. The torque converter as recited in claim 1 wherein the connector plate is centered by the spring.

6. The torque converter as recited in claim 1 wherein the spring is an arc spring.

7. The torque converter as recited in claim 1 wherein the clutch plate and the connector plate are splined together with lash.

8. The torque converter as recited in claim 1 wherein the connector plate is centered by the cover plate.

9. The torque converter as recited in claim 1 wherein the cover plate is located axially toward an engine side with respect to the connector plate to prevent movement of the connector plate towards the engine.

10. The torque converter as recited in claim 1 wherein the movement of the cover plate towards a transmission side is axially restricted.

11. The torque converter as recited in claim 1 wherein the piston is located axially between the connector plate and the clutch plate.
